(19) United States
(12) Patent Application Publication
(10) Pub. No.: US 2026/0156349 A1
(43) Pub. Date: Jun. 4, 2026

(54) MEDIA CONTENT BETWEEN DEVICES BASED ON MEDIA SPECIFICATIONS

(71) Applicant: Lenovo (Beijing) Limited, Beijing (CN)

(72) Inventors: Amit Kumar Agrawal, Bangalore (IN); Xuejin Wang, Xiamen (CN); Yidong Liu, Xiamen (CN)

(73) Assignee: Lenovo (Beijing) Limited, Beijing (CN)

(21) Appl. No.: 19/373,351

(22) Filed: Oct. 29, 2025

Related U.S. Application Data
(63) Continuation of application No. PCT/CN2024/136471, filed on Dec. 3, 2024.

(51) Int. Cl. H04N 23/60; H04N 23/62; H04N 23/661

(52) U.S. Cl. CPC H04N 23/64; H04N 23/62; H04N 23/661

(57) ABSTRACT

Techniques for media content between devices based on media specifications are described and are implementable to enable media content to be obtained (e.g., captured, retrieved) in compliance with particular media specifications. The described implementations, for example, utilize specified media specifications (e.g., media constraints) to be utilized as part of a media capture process. For instance, a first client device receives a media request from a second client device for media content that complies with one or more media specifications. The first client device can obtain (e.g., capture, retrieve) an instance of media content based at least in part on the one or more media specifications, and communicate the instance of media content to the second client device.

### RELATED APPLICATION

This application claims priority benefit of Application Number PCT/CN2024/136471 filed 03 December 2024 entitled “Media Content Between Devices based on Media Specifications,” the disclosure of which is incorporated by reference herein in its entirety.

### BACKGROUND

Today’s person is afforded a tremendous selection of devices that are capable of performing a multitude of tasks. For instance, desktop and laptop computers provide computing power and screen space for productivity and entertainment tasks. Further, smartphones and tablets provide computing power and communication capabilities in highly portable form factors. In interacting with devices user’s often encounter scenarios where input of an instance of media content is available. For instance, a user can provide instances of media content to particular applications for various purposes. A social media application, for example, can receive digital photos from a user for publication. In another example, an enterprise application can provide an input field that can receive an image of a user signature for authorizing a particular action.

Current implementations for media content input, however, demonstrate a number of drawbacks. For instance, current digital cameras implemented in a typical device (e.g., a smartphone) capture high-quality images at increasing levels of resolution. However, many applications have memory and/or aspect ratio limitations such that a typical captured digital image is not usable unless some form of post processing is applied to reduce file size and/or image size. Thus, in many scenarios a user is required to capture an instance of media content and then apply post-capture processing to the media content to conform to media specifications of a particular application. This not only causes user frustration but wastes system resources (e.g., processor bandwidth, memory, network bandwidth) required to apply the post processing to the media content. Further, many users are inexperienced in digital media editing and thus their attempts to edit media to meet media specifications may result in media that still does not comply with particular media specifications and/or poor quality media.

### BRIEF DESCRIPTION OF THE DRAWINGS

Aspects of media content between devices based on media specifications are described with reference to the following Figures. The same numbers may be used throughout to reference similar features and components that are shown in the Figures. Further, identical numbers followed by different letters reference different instances of features and components described herein.

FIG. 1 illustrates an example environment in which aspects of media content between devices based on media specifications can be implemented.

FIG. 2 depicts an example system for media content between devices based on media specifications in accordance with one or more implementations.

FIG. 3 illustrates an example scenario in accordance with aspects of the present disclosure.

FIG. 4 illustrates a flow chart depicting an example method for media content between devices based on media specifications in accordance with one or more implementations.

FIG. 5 illustrates a flow chart depicting an example method for utilizing user guidance for obtaining media content in accordance with one or more implementations.

FIG. 6 illustrates various components of an example device 500 in which aspects of media content between devices based on media specifications can be implemented.

### DETAILED DESCRIPTION

Techniques for media content between devices based on media specifications are described and may be implemented to enable media content to be captured and/or obtained in compliance with particular media specifications. The described implementations, for instance, utilize specified media specifications (e.g., media constraints) to be utilized as part of a media capture process and in at least some implementations do not utilize post processing to enable compliance with stated media specifications. Further, media specifications can be communicated between devices to enable media content to be captured at a first client device based on media specifications, and the media content to be communicated to a second client device. This provides for greater automation and user convenience than is provided by traditional techniques for obtaining media content.

For instance, consider a scenario where an application operating on the second client device is configured to receive media input. A particular application, for example, presents a prompt for inputting a digital image, such as a user photo for a user profile (e.g., for a social media application), an image of a user’s signature (e.g., to authorize a particular document and/or action), an image of a visual object (e.g., an image of a house for a real estate application), and so forth. Further, the application implements specific media specifications (e.g., constraints) for digital image input, such as maximum file size, maximum resolution, maximum image size, aspect ratio (e.g., 16:9, 4:3), image orientation (e.g., landscape, portrait), etc. Accordingly, to enable a digital image to be obtained that complies with the media specifications, The second client device can generate a media request and transmit the media request to the first client device. Further, the media request can include the media specifications.

The first client device can receive the request, identify the media specifications, and cause an instance of media content to be obtained that complies with the media specifications. The first client device, for example, can utilize a media capture device (e.g., a camera, a microphone) to capture the instance of media content. In at least some implementations, the first client device can automatically identify the media specifications and cause a media capture device to obtain an instance of media content in compliance with the media specifications. For instance, in an image capture scenario, default image capture settings of an image capture device can be modified such that a captured image does not exceed media constraints specified by the media specifications. In an audio capture scenario, default audio capture settings of an audio capture device can be modified such that captured audio does not exceed media constraints specified by the media specifications. In at least one implementation this enables a captured digital image and/or digital audio to be provided without utilizing post processing to modify the captured image and/or captured audio to comply with the media specifications.

In alternative or additional implementations, media specifications for an application can be utilized to obtain media content that complies with media specifications from a group of existing media content. For instance, in a digital image scenario, media specifications for the application can specify media constraints, and may also specify image content (e.g., visual objects) to be included in a digital image. Accordingly, the media specifications can be utilized at the first client device to perform an automated search of a group of digital images to identify a particular digital image that complies with the media specifications, e.g., media constraints and/or a specified visual object. The particular digital image can be communicated to the second client device.

In a digital audio scenario, media specifications for the application can specify audio media constraints, and may also specify audio content (e.g., keywords) to be included in digital audio. Accordingly, the media specifications can be utilized at the first client device to perform an automated search of digital audio to identify an instance of digital audio that complies with the media specifications, e.g., media constraints and/or specified audio content. The instance of digital audio can be communicated to the second client device.

The described techniques enable media content to be automatically obtained (e.g., captured and/or identified) in compliance with media specifications and without requiring manual interactions to modify media content to comply with media specifications. The described techniques can be utilized to obtain various types of media content in compliance with media specifications, such as digital video, digital audio, etc.

Accordingly, the described techniques are automated and are able to obtain media content in compliance with media specifications without user interaction to obtain media specifications and/or to modify media content to comply with media specifications.

While features and concepts of media content between devices based on media specifications can be implemented in any number of environments and/or configurations, aspects the described techniques are described in the context of the following example systems, devices, and methods. Further, the systems, devices, and methods described herein are interchangeable in various ways to provide for a wide variety of implementations and operational scenarios.

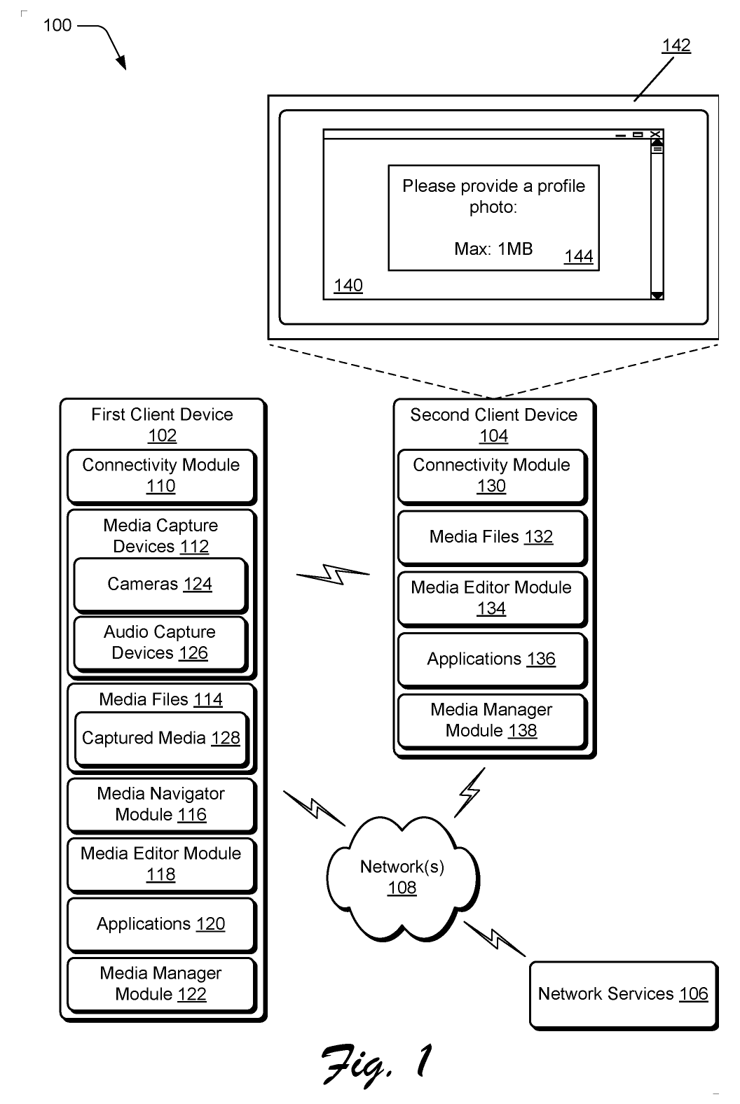

FIG. 1 illustrates an example environment 100 in which aspects of media content between devices based on media specifications can be implemented. The environment 100 includes a first client device 102, a second client device 104, and network services 106 that are interconnectable in various ways such as via connectivity to a network 108. The first client device 102, the second client device 104, and the network services 106, for instance, are interconnectable via wireless and/or wired connectivity to the network 108. The first client device 102 and the second client device 104 can also communicate via direct device-to-device connectivity, such as independent of the network 108. The first client device 102 and the second client device 104 can be implemented in various ways and according to various form factors such as a smartphone, tablet device, a laptop computer, a desktop computer, a wearable computing device, and so forth

The first client device 102 includes various functionality that enables the first client device 102 to perform different aspects of media content between devices based on media specifications discussed herein, including a connectivity module 110, media capture devices 112, media files 114, a media navigator module 116, a media editor module 118, applications 120, and a media manager module 122. The connectivity module 110 represents functionality (e.g., logic and hardware) for enabling the first client device 102 to interconnect with other devices and/or networks, such as the second client device 104, the network 108, and the network services 106. The connectivity module 110, for instance, enables wireless and/or wired connectivity of the first client device 102. In a wireless scenario the connectivity module 110 enables connectivity and data communication via a variety of different wireless protocols, such as wireless broadband, Wireless Local Area Network (WLAN) (e.g., Wi-Fi), Wi-Fi Direct, wireless short distance communication (e.g., Bluetooth (including Bluetooth Low Energy (BLE)), Near Field Communication (NFC)), and so forth. In implementations, the connectivity module 110 can enable direct device-to-device communication of the first client device 102 with other devices, such as the second client device 104.

The media capture devices 112 are representative of functionality to enable various types of media to be captured via the computing device, such as visual media and audio media. In this particular example the media capture devices 112 include cameras 124 and audio capture devices 126. The media capture devices 112, however, can include a variety of other devices that are able to capture various types of media in accordance with the implementations discussed herein. The media capture devices 112 can include hardware for capturing associated media as well as logic (e.g., drivers, firmware, etc.) for operating and configuring operation of the associated media capture devices 112.

The media files 114 represent instances of different digital media captured by, stored by, and/or available to the first client device 102. For instance, the media files 114 can be stored locally on the first client device 102 and/or obtained from a network service 106. Examples of the media files 114 include digital images, digital video, digital audio, and combinations thereof. The media files 114, for instance, include captured media 128 which represent instances of digital media captured by the media capture devices 112. The media navigator module 116 represents functionality for navigating through and/or selecting instances of media files 114. For instance, the media navigator module 116 exposes functionality that enables a user to navigate through and select instances of the media files. Further, the media navigator module 116 includes automated functionality for identifying and/or selecting instances of media files 114 based on various selection criteria, such as media type, file size, media content, various media characteristics (e.g., visual and/or audible characteristics), and so forth.

The media editor module 118 represents functionality for editing digital media, such as instances of the media files 114. For instance, the media editor module 118 is operable as an image editor for editing characteristics of visual media files (e.g., digital images, digital video), as an audio editor for editing characteristics of audio files (e.g., audio attributes), and so forth. The applications 120 represent functionality for performing different computing tasks via the first client device 102, such as gaming, media consumption (e.g., content streaming), productivity tasks (e.g., word processing, content generation, data analysis, etc.), ecommerce, enterprise tasks, content generation, web browsing, communication with other devices, and so forth. The applications 120 can be implemented in various ways, such as applications stored on and executed by the first client device 102, network-based applications that expose functionality via the first client device 102, and so forth.

The media manager module 122 represents functionality for performing various aspects of media content between devices based on media specifications described herein, such as for enabling media content that meets various criteria to be obtained, e.g., captured and/or selected. As described throughout this disclosure, the first client device 102 can receive communication (e.g., a request) from the second client device 104 for an instance of media content that complies with one or more media specifications. The media manager module 122 can enable an instance of media content to be obtained (e.g., captured, selected) that complies with the one or more media specifications, and the first client device 102 can communicate the instance of media content to the second client device 104.

The second client device 104 includes various functionality that enables the first client device 102 to perform different aspects of media content between devices based on media specifications discussed herein, including a connectivity module 130, media files 132, a media editor module 134, applications 136, and a media manager module 138. The connectivity module 130 represents functionality (e.g., logic and hardware) for enabling the second client device 104 to interconnect with other devices and/or networks, such as the first client device 102, the network 108, and the network services 106. The connectivity module 130, for instance, enables wireless and/or wired connectivity of the second client device 104. n a wireless scenario the connectivity module 130 enables connectivity and data communication via a variety of different wireless protocols, such as wireless broadband, Wireless Local Area Network (WLAN) (e.g., Wi-Fi), Wi-Fi Direct, wireless short distance communication (e.g., Bluetooth(including Bluetooth Low Energy (BLE)), Near Field Communication (NFC)), and so forth. In implementations, the connectivity module 130 can enable direct device-to-device communication of the second client device 104 with other devices, such as the first client device 102.

The media files 132 represent instances of different digital media content obtained by the second client device 104. The media files 132, for instance, can be captured by the second client device 104 and/or obtained by a data storage accessible to the second client device 104. As discussed throughout this disclosure, instances of the media files 132 can be obtained from the first client device 102, such as based on requests from the second client device 104 to the first client device 102 for instances of media content.

The media editor module 134 represents functionality for editing digital media, such as instances of the media files 132. For instance, the media editor module 134 is operable as an image editor for editing characteristics of visual media files (e.g., digital images, digital video), as an audio editor for editing characteristics of audio files (e.g., audio attributes), and so forth. The applications 136 represent functionality for performing different computing tasks via the second client device 104, such as gaming, media consumption (e.g., content streaming), productivity tasks (e.g., word processing, content generation, data analysis, etc.), ecommerce, enterprise tasks, content generation, web browsing, communication with other devices, and so forth. The applications 136 can be implemented in various ways, such as applications stored on and executed by the second client device 104, network-based applications that expose functionality via the second client device 104, and so forth.

The media manager module 138 represents functionality for performing various aspects of media content between devices based on media specifications described herein such as for enabling media content that meets various media specifications (e.g., criteria, constraints) to be obtained, e.g., captured and/or selected. As described throughout this disclosure, the second client device 104 can send (e.g., transmit) communication (e.g., a request) to the first client device 102 for an instance of media content that complies with one or more media specifications. The second client device 104 can receive, from the first client device 102, an instance of media content based on the communication. The media manager module 138 can process the received instance of media content to verify that the instance of media content complies with the one or more media specifications. In implementations, the instance of media content can be provided to an application 136, such as in response to a request from the application 136 for an instance of media content.

For instance, consider that an application 136 presents an application graphical user interface (GUI) 140 on a display device 142 of the second client device 104. Further, the application GUI 140 includes a media prompt 144 that indicates that the application 136 is configured to receive input of media content. Input of media content to the application 136 can be based on one or more different media specifications, such as constraints on file size and/or other media attributes. Further, the application 136 can request specific media content to be included in media content to be input to the application 136. For instance, the media manager module 138 can analyze the application GUI 140 to determine that the graphical user interface identifies the one or more media specifications. Accordingly, the media manager module 138 can ascertain the one or more media specifications and communicate a request to the first client device 102 for an instance of media content that complies with the one or more media specifications. The first client device 102 can obtain an instance of media content that complies with the one or more media specifications, and communicate the instance of media content to the second client device 104. The media manager module 138 can cause the received instance of media content to be provided to the application 136.

The network services 106 represent different network-accessible services that are accessible by the first client device 102 and the second client device 104 for various purposes. Examples of the network services 106 include websites, web-based services, cloud services, network-based enterprise services, and so forth. In at least one implementation the network services 106 implement instances of the applications 120, 136 that enable interaction with respective network services 106. For example, the first client device 102 and/or the second client device 104 can access various network services 106 via interaction with respective applications 120, 136.

Having discussed an example environment in which the disclosed techniques can be performed, consider now an example system for implementing the disclosed techniques.

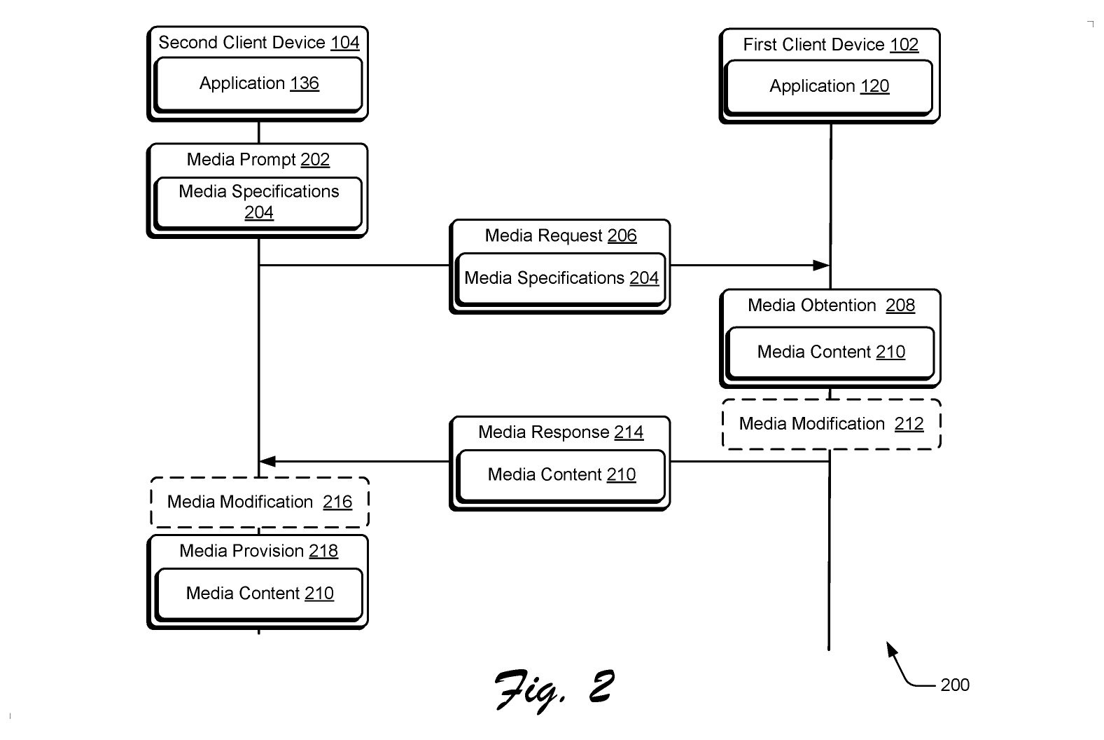

FIG. 2 depicts an example system 200 for media content between devices based on media specifications in accordance with one or more implementations. The system 200 can be implemented in the environment 100 and incorporates attributes of the environment 100 introduced above. In the system 200 an application 136 on the second client device 104 initiates a media prompt 202 indicating that the application 136 is in a media input mode where the application 136 is configured to receive input of media content. In at least one implementation the media prompt 202 is based on an application GUI for the application 136 that includes a media input functionality, such as a media input field for providing media input to the application 136. The media prompt 202 can occur in various ways. For instance, the application 136 generates the media prompt 202 automatically and based on implementing functionality of the application 136 for receiving media input

The media prompt 202 includes and/or is associated with one or more media specifications 204 that indicate one or more criteria (e.g., constraints) for media content to be input to the application 136. The media specifications 204 can include various types and instances of media specifications, such as media constraints including maximum and/or minimum values for media content to be input to the application 136. For instance, where the media prompt 202 is based on visual media content (e.g., a digital image and/or digital video) the media specifications 204 can include specifications for digital visual media such as maximum file size, maximum or minimum media resolution, target aspect ratio, a maximum, and/or minimum bitrate, supported image and/or video compression protocol(s), etc. In an alternative or additional example, where the media prompt 202 is based on audio media content, the media specifications 204 can include specifications for audio media such as maximum file size, a specified maximum bitrate, maximum audio content duration, supported audio compression protocol(s), etc.

Based at least in part on the media prompt 202, the second client device 104 communicates a media request 206 to the first client device 102 requesting one or more instances of media content that comply with the media specifications 204. The first client device 102 receives the media request 206 and performs media obtention 208 to obtain an instance of media content 210. The media obtention 208, for instance, can be performed via invoking one or more of the media capture devices 112 to capture the instance of media content 210. Alternatively, or additionally, the media obtention 208 can include searching existing (e.g., stored) media files 114 to retrieve the media content 210. In an optional implementation, the first client device 102 can perform media modification 212 to modify the media content 210 to comply with the media specifications 204. For instance, the media modification 212 can include implementing the media editor module 118 to modify one or more attributes of the media content 210, such as reducing file size, modifying (e.g., reducing) image resolution, modifying image aspect ratio, modifying (e.g., reducing) bitrate, etc.

The first client device 102 can generate a media response 214 that includes the media content 210 and communicate the media response 214 to the second client device 104. In an optional implementation, the media response 214 includes a modified version of the media content 210, such as modified via the media modification 212. The second client device 104 can receive the media response 214 with the media content 210. In an optional implementation, the second client device 104 can perform media modification 216 to modify the media content 210 to comply with the media specifications 204. For instance, the media modification 216 can include implementing the media editor module 134 to modify one or more attributes of the media content 210, such as reducing file size, modifying (e.g., reducing) image resolution, modifying image aspect ratio, modifying (e.g., reducing) bitrate, etc.

The second client device 104 can perform media provision 218 to provide the instance of media content 210 to the application 136. In at least one implementation, the media manager module 122 can cause the media content 210 to be provided to the application 136, such as via input to a media prompt output by the application 136

In one or more implementations, the different actions described with reference to the system 200 can be implemented (e.g., initiated, triggered) by respective instances of the applications 120, 136. For instance, the application 136 on the second client device 104 can communicate with a respective instance of the application 120 on the first client device 102 to cause the media content 210 to be obtained at the first client device 102 and communicated to the second client device 104

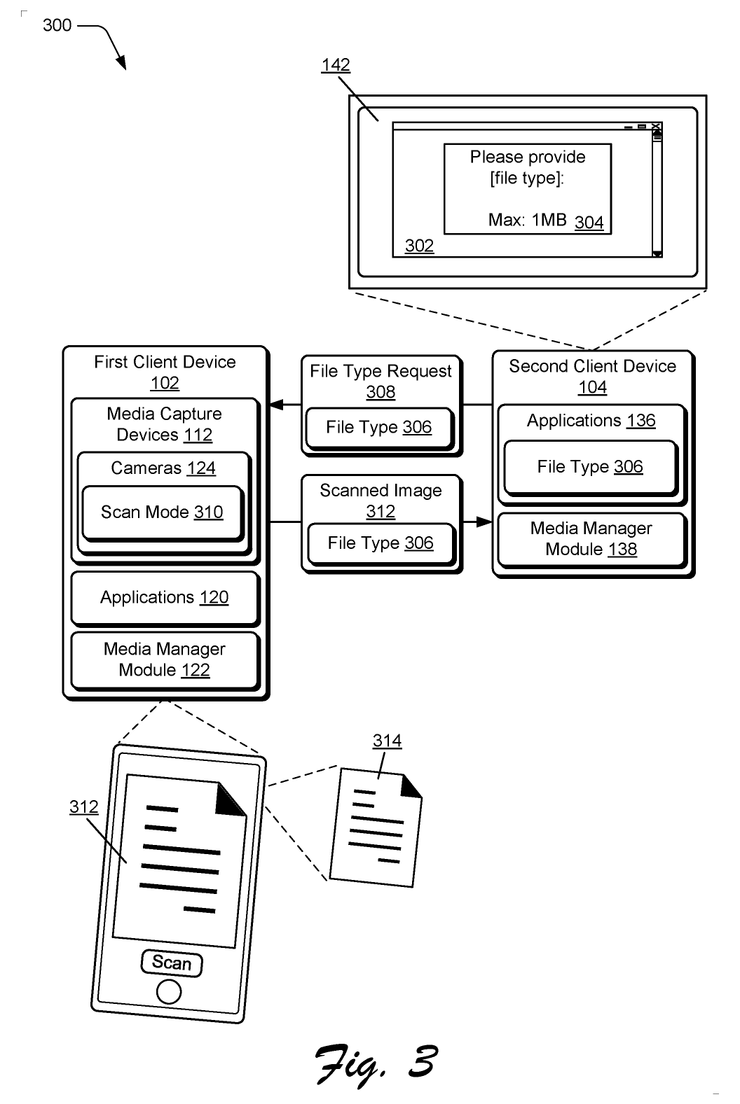

FIG. 3 illustrates an example scenario 300 in accordance with aspects of the present disclosure. In the scenario 300, an application 136 presents an application GUI 302 on the display device 142 of the second client device 104. Further, the application GUI 302 includes a media prompt 304 that indicates that the application 136 is configured to receive input of media content of a particular file type 306. For instance, the file type 306 represents a specific filename extension. In at least one implementation, the file type 306 represents a portable document format (PDF) file type. The media manager module 138 determines the file type 306 and transmits a file type request 308 to the first client device 102 for a media file of the file type 306. In implementations, in addition to specifying a particular file type, the file type request 308 may include different media specifications, such as discussed throughout this disclosure

Further to the scenario 300, the first client device 102 receives the file type request 308 and based on the file type 306, the media manager module 122 activates a scan mode 310 of a camera 124. For instance, the scan mode 310 is automatically activated based on detecting the request for the file type 306. In the scan mode 310, the camera 124 captures a scanned image 312 of a visual object 314, e.g., a physical document. The scanned image 312, for example, represents a digital representation of the visual object 314 in the file type 306. The scanned image 312 may also be captured to correspond to different media specifications, such as specified by the application 136 and as described throughout this disclosure. The first client device 102 transmits the scanned image 312 to the second client device 104, and the media manager module 138 causes the scanned image 312 to be communicated to the application 136. The scanned image 312, for example, can be provided as an instance of media content to the media prompt 304

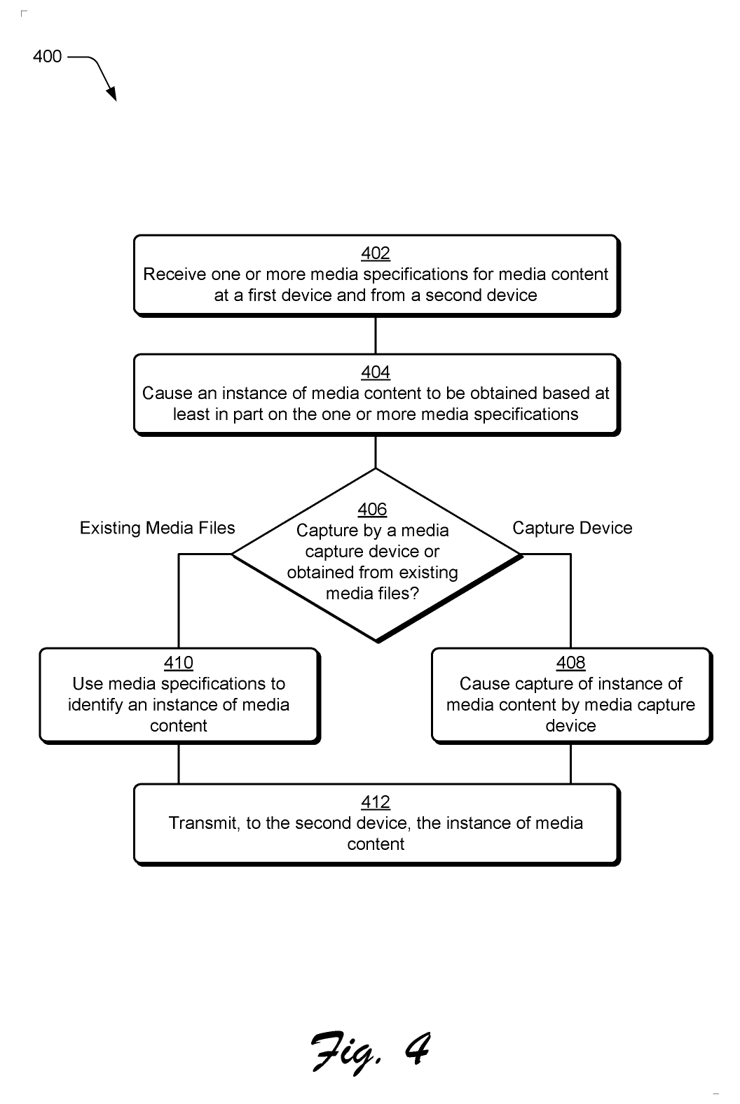

FIG. 4 illustrates a flow chart depicting an example method 400 for media content between devices based on media specifications in accordance with one or more implementations. At 402, one or more media specifications for media content are received at a first device and from a second device. The first client device 102, for example, receives a media request from the second client device 104 requesting one or more instances of media content and including one or more media specifications for the media content. As discussed throughout this disclosure, the media specifications can include various criteria (e.g., constraints) for media input to the application, such as a maximum file size, a maximum image size, a maximum playback length, target aspect ratio, media encoding type, and other media attributes. Alternatively, or additionally the media specifications include subject matter to be included in media content, such as image features (e.g., visual objects included in images), audio features (e.g., keywords), and so forth. In at least one implementation, the first client device 102 receives from the second client device 104 a notification to activate one or more media capture devices and to capture the instance of media by the one or more media capture devices based at least in part on the one or more media specifications. In implementations, the one or more media specifications may include metadata that describes subject matter for the instance of media content

At 404 an instance of media content is caused to be obtained based at least in part on the one or more media specifications. The instance of media content, for example, can be captured via a media capture device 112 and/or obtained from stored media files 114. At 406 it is determined whether an instance of media content is to be captured by a media capture device or obtained from a group of existing media files. Various state conditions can be considered in determining whether to capture the instance of media content via a media capture device 112 or to search the media files 114 for the instance of media content. For example, in a scenario where an application and/or a user invokes a media capture device 112, this indicates that an instance of media content is to be captured by the media capture device 112 In scenario where an application and/or a user does not invoke a media capture device 112, and/or when a media capture device 112 is not available (e.g., is offline and/or non-functional), an instance of media content can be obtained from the media files 114

If the instance of media content is to be captured by a media capture device (“Capture Device”) at 408 an instance of the media content is caused to be captured by a media capture device of the computing device based on the one or more media specifications. The media specifications, for example, are communicated to a media capture device 112 (e.g., by an application 120 and/or the media manager module 122) and the media capture device 112 captures an instance of media content that complies with the media specifications. For instance, in a visual media scenario, a camera 124 captures an instance of visual media (e.g., a digital image, digital video) that corresponds to the media specifications. As an example, where the media specifications specify a maximum file size, attributes of visual media are modified (e.g., reduced) from default image capture settings to enable captured visual media to not exceed the maximum file size. In another example wherein the media content is audio content, attributes of the audio content are modified to enable captured audio content to not exceed a maximum file size

If the instance of media content is to be obtained from existing media files (“Existing Media Files”), at 410 the media specifications are utilized to identify an instance of media content. The media manager module 122, for example, communicates the media specifications to the media navigator module 116 and the media navigator module 116 utilizes the media specifications to search the media files 114 and identify an instance of media content of a content type requested by the application and that complies with the media specifications

In at least one implementation the media navigator module 116 identifies an instance of media content that is modifiable to comply with media specifications. For instance, for visual media content, the media specifications specify content for an instance of visual media content, e.g., a visual object to be included in visual media content. The media specifications also specify media constraints, such as maximum file size, maximum image size, target aspect ratio, etc. Accordingly, the media navigator module 116 identifies an instance of visual media content that includes specified content but that does not comply with media constraints. In such a scenario the media editor module 118 can automatically modify the instance of visual media content to comply with the media constraints, such as by applying file compression, image cropping, aspect ratio adjustment, etc., to generate a modified version of the visual media content that complies with media constraints specified by the media specifications

In a scenario where audio media content is to be obtained, media specifications can specify content for audio media content (e.g., user-specific voice content, keywords, key phrases, content creation date, etc.) and media constraints for the audio content such as maximum file size, maximum playback length, maximum bitrate, etc. Accordingly, the media navigator module 116 identifies an instance of audio media content that includes specified audio content but that does not comply with media constraints. In such a scenario the media editor module 118 can automatically modify the instance of audio media content to comply with the media constraints, such as by applying file compression, modifying (e.g., reducing) playback length, modifying (e.g., reducing) bitrate, etc., to generate a modified version of the audio media content that complies with media constraints specified by the media specifications

In implementations, the process of identifying the instance of media content and/or modifying the instance of media content to comply with media constraints can be performed automatically without user interaction to select an instance of media content and/or modify the instance of media content

At 412 the instance of media content is transmitted to the second device. The first client device 102, for instance, transmits the instance of media content to the second client device 104

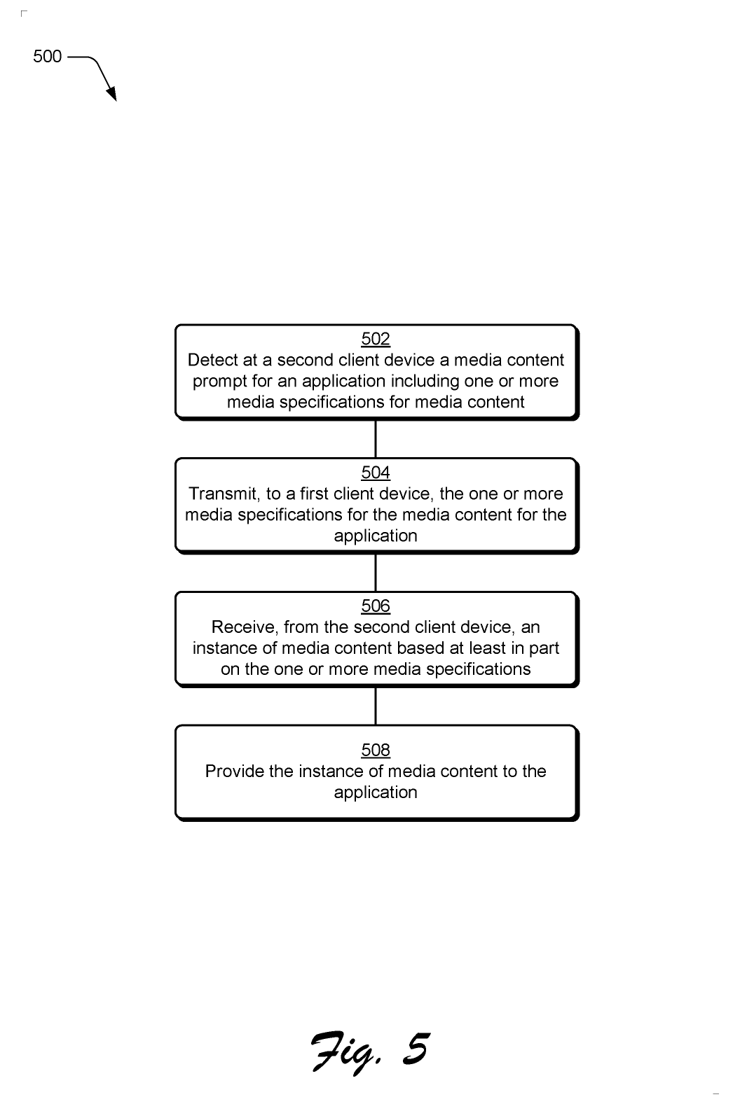

FIG. 5 illustrates a flow chart depicting an example method 500 for utilizing user guidance for obtaining media content in accordance with one or more implementations. The method 500, for example, is implemented in conjunction with the method 400 for obtaining an instance of media content for an application. At 502, a media content prompt for an application is detected at a second client device including one or more media specifications for media content. The media manager module 138 at the second client device 104, for instance, detects that an application 136 includes a prompt (e.g., a request) for an instance of media content. Further, the media manager module 138 determines one or more media specifications for the instance of media content

At 504, the one or more media specifications for the media content for the application are transmitted to a second client device. The second client device 104, for instance, transmits a media request to the first client device 102 including the one or more media specifications. At 506 an instance of media content is received from the second client device and based at least in part on the one or more media specifications. The second client device 104, for example, receives an instance of media content that complies with the one or more media specifications. Alternatively, or additionally, the second client device 104 receives an instance of media content from the first client device 102, and the second client device 104 modifies one or more attributes of the instance of media content to comply with the one or more media specifications. At 508 the instance of media content is provided to the application. The media manager module 122, for instance, provides the instance of media content to the application 120 that queries and/or prompts for an instance of media content

The example methods described above may be performed in various ways, such as for implementing different aspects of the systems and scenarios described herein. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations can be performed in any order to perform a method, or an alternate method.

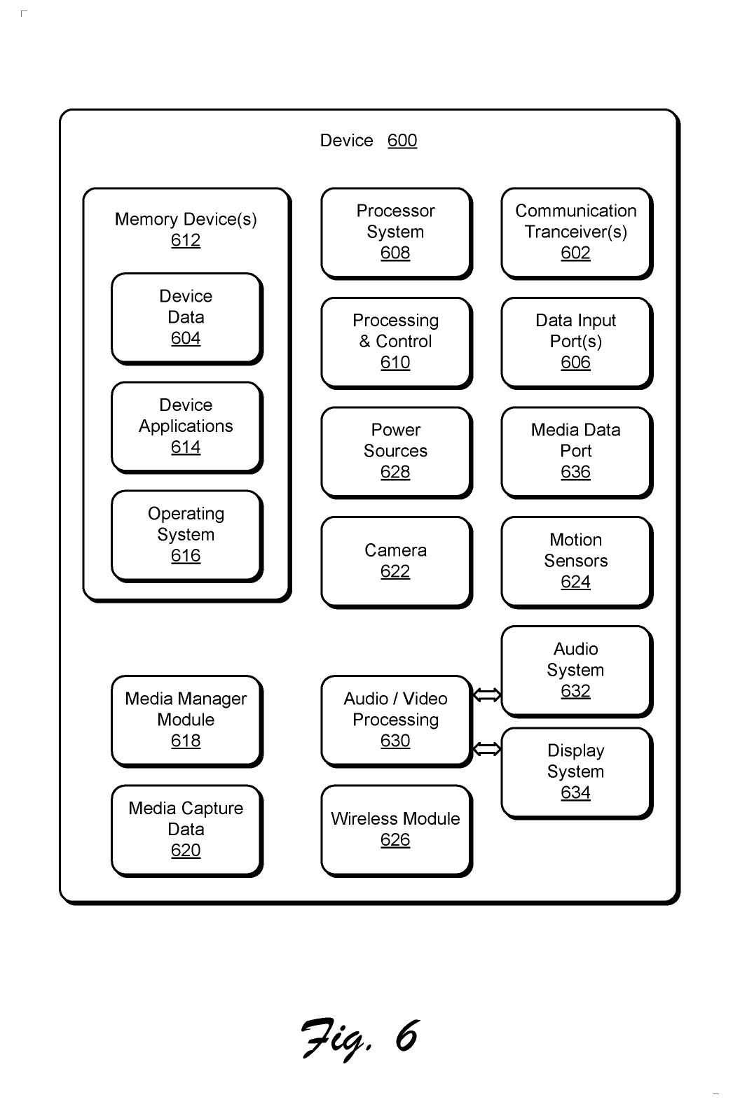

FIG. 6 illustrates various components of an example device 600 in which aspects of media content between devices based on media specifications can be implemented. The example device 600 can be implemented as any of the devices described with reference to the previous FIGS. 1-5, such as any type of mobile device, mobile phone, mobile device, wearable device, tablet, computing, communication, entertainment, gaming, media playback, and/or other type of electronic device. For example, the first client device 102 and/or the second client device 104 as shown and described with reference to FIGS. 1-5 may be implemented as the example device 600.

The device 600 includes communication transceivers 602 that enable wired and/or wireless communication of device data 604 with other devices. The device data 604 can include any of device identifying data, device location data, wireless connectivity data, and wireless protocol data. Additionally, the device data 604 can include any type of audio, video, and/or image data. Example communication transceivers 602 include wireless personal area network (WPAN) radios compliant with various IEEE 802.15 (Bluetooth) standards, wireless local area network (WLAN) radios compliant with any of the various IEEE 802.11 (Wi-Fi^{TM}) standards, wireless wide area network (WWAN) radios for cellular phone communication, wireless metropolitan area network (WMAN) radios compliant with various IEEE 802.16 (WiMAXs) standards, and wired local area network (LAN) Ethernet transceivers for network data communication.

The device 600 may also include one or more data input ports 606 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 600 includes a processing system 608 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are generally identified at 610. The device 600 may further include any type of a system bus or other data and command transfer system that couples the various components within the device. A system bus can include any one or combination of different bus structures and architectures, as well as control and data lines.

The device 600 also includes computer-readable storage memory 612 (e.g., memory devices) that enable data storage, such as data storage devices that can be accessed by a computing device, and that provide persistent storage of data and executable instructions (e.g., software applications, programs, functions, and the like). Examples of the computer-readable storage memory 612 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 600 may also include a mass storage media device.

The computer-readable storage memory 612 provides data storage mechanisms to store the device data 604, other types of information and/or data, and various device applications 614 (e.g., software applications). For example, an operating system 616 can be maintained as software instructions with a memory device and executed by the processing system 608. The device applications may also include a device manager, such as any form of a control application, software application, signal-processing and control module, code that is native to a particular device, a hardware abstraction layer for a particular device, and so on. Computer-readable storage memory 612 represents media and/or devices that enable persistent and/or non-transitory storage of information in contrast to mere signal transmission, carrier waves, or signals per se. Computer-readable storage memory 612 do not include signals per se or transitory signals.

In this example, the device 600 includes a media manager module 618 that implements aspects of media content between devices based on media specifications and may be implemented with hardware components and/or in software as one of the device applications 614. For example, the media manager module 618 can be implemented as the media manager module 122 and/or the media manager module 138, described in detail above. In implementations, the media manager module 618 may include independent processing, memory, and logic components as a computing and/or electronic device integrated with the device 600. The device 600 also includes media capture data 620 for implementing aspects of media content between devices based on media specifications and may include data from the media manager module 618, such as media specifications for different instances of applications 120, 136.

In this example, the example device 600 also includes a camera 622 and motion sensors 624, such as may be implemented in an inertial measurement unit (IMU). The motion sensors 624 can be implemented with various sensors, such as a gyroscope, an accelerometer, and/or other types of motion sensors to sense motion of the device. The various motion sensors 624 may also be implemented as components of an inertial measurement unit in the device.

The device 600 also includes a wireless module 626, which is representative of functionality to perform various wireless communication tasks. The device 600 can also include one or more power sources 628, such as when the device is implemented as a mobile device. The power sources 628 may include a charging and/or power system, and can be implemented as a flexible strip battery, a rechargeable battery, a charged super-capacitor, and/or any other type of active or passive power source.

The device 600 also includes an audio and/or video processing system 630 that generates audio data for an audio system 632 and/or generates display data for a display system 634. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 636. In implementations, the audio system and/or the display system are integrated components of the example device. Alternatively, the audio system and/or the display system are external, peripheral components to the example device.

Although implementations of media content between devices based on media specifications have been described in language specific to features and/or methods, the subject of the appended claims is not necessarily limited to the specific features or methods described. Rather, the features and methods are disclosed as example implementations, and other equivalent features and methods are intended to be within the scope of the appended claims. Further, various different examples are described, and it is to be appreciated that each described example can be implemented independently or in connection with one or more other described examples. Additional aspects of the techniques, features, and/or methods discussed herein relate to one or more of the following

In addition to the previously described methods, any one or more of the following

In some aspects, the techniques described herein relate to a first client device, including: at least one memory; and at least one processor coupled with the at least one memory and configured to cause the first client device to: receive, from a second client device, one or more media specifications for media content; cause an instance of media content to be obtained based at least in part on the one or more media specifications; and transmit, to the second client device, the instance of media content

In some respects, the techniques described herein relate to a first client device, wherein the one or more media specifications are received at a first instance of an application at the first client device and from a second instance of the application at the second client device

In some aspects, the techniques described herein relate to a first client device, wherein the one or more media specifications include a maximum media file size for media content, and wherein to cause the instance of media content to be obtained, the at least one processor is configured to cause the first client device to communicate an instruction to a media capture device to capture the instance of media content with a file size that does not exceed the maximum media file size

In some aspects, the techniques described herein relate to a first client device, wherein the one or more media specifications are associated with one or more of digital image media or digital audio media, and where the instance of media content includes one or more of an instance of digital image media or digital audio media obtained based at least in part on the one or more media specifications

In some aspects, the techniques described herein relate to a first client device, wherein the at least one processor is configured to cause the first client device to: transmit, to the second client device, an indication that one or more media capture devices are activated on the first client device; and receive, based at least in part on the indication, the one or more media specifications for media content

In some aspects, the techniques described herein relate to a first client device, wherein the indication includes an indication that an application on the first client device activates the one or more media capture devices

In some aspects, the techniques described herein relate to a first client device, wherein the at least one processor is configured to cause the first client device to receive, from the second client device, a notification to activate one or more media capture devices and to capture the instance of media by the one or more media capture devices based at least in part on the one or more media specifications

In some aspects, the techniques described herein relate to a first client device, wherein to obtain the instance of media content, the at least one processor is configured to cause the first client device to: search a data storage for previously captured media content that corresponds to the one or more media specifications; and obtain the instance of media content from the previously captured media content of the data storage and based at least in part on the one or more media specifications

In some aspects, the techniques described herein relate to a first client device, wherein the one or more media specifications include metadata that describes subject matter for the instance of media content

In some aspects, the techniques described herein relate to a first client device, wherein the at least one processor is configured to cause the first client device to: specify user guidance for adjusting one or more media capture attributes of a media capture device; and capture, by a media capture device of the first client device, the instance of media content based at least in part on the one or more media specifications and the user guidance

In some aspects, the techniques described herein relate to a second client device, including: at least one memory; and at least one processor coupled with the at least one memory and configured to cause the second client device to: transmit, to a first client device, one or more media specifications for media content for an application; receive, from the second client device, an instance of media content based at least in part on the one or more media specifications; and provide the instance of media content to the application

In some aspects, the techniques described herein relate to a second client device, wherein the at least one processor is configured to cause the second client device to transmit a notification to the first client device to invoke a media capture device of the first client device for capturing the instance of media content

In some aspects, the techniques described herein relate to a second client device, wherein the notification includes a notification generated by a first instance of the application at the second client device and configured for a second instance of the application at the first client device

In some aspects, the techniques described herein relate to a second client device, wherein the at least one processor is configured to cause the second client device to identify the one or more media specifications by analyzing a graphical user interface for the application to determine that the graphical user interface identifies the one or more media specifications

In some aspects, the techniques described herein relate to a second client device, wherein the one or more media specifications include a maximum media file size for media content

### In some aspects, the techniques described herein relate to a second client device, wherein the at least one processor is configure to cause the second client device to: receive a notification that a media capture device on the first client device is activated; and transmit the one or more media specifications to the first client device based at least in part on the notification

IN SOME ASPECTS, THE TECHNIQUES DESCRIBED HEREIN RELATE TO A SECOND CLIENT DEVICE, WHEREIN THE ONE OR MORE MEDIA SPECIFICATIONS INCLUDE METADATA THAT DESCRIBES SUBJECT MATTER FOR THE INSTANCE OF MEDIA CONTENT

In some aspects, the techniques described herein relate to a second client device, wherein the at least one processor is configured to cause the second client device to transmit an indication specifying user guidance for adjusting one or more media capture attributes of a media capture device of the first client device

In some aspects, the techniques described herein relate to a second client device, wherein the at least one processor is configured to cause the second client device to: determine that the instance of media content does not comply with at least one media specification of the one or more media specifications; and transmit, to the first client device, a request for a further instance of media content that complies with the at least one media specification of the one or more media specifications

In some aspects, the techniques described herein relate to a method, including: receiving, at a first client device and from a second client device, one or more media specifications for media content; causing an instance of media content to be obtained based at least in part on the one or more media specifications; and transmitting, to the second client device, the instance of media content

1. A first client device, comprising:
at least one memory; and
at least one processor coupled with the at least one memory and configured to cause the first client device to:
receive, from a second client device, one or more media specifications for media content;
cause an instance of media content to be obtained based at least in part on the one or more media specifications; and
transmit, to the second client device, the instance of media content.

2. The first client device of claim 1, wherein the one or more media specifications are received at a first instance of an application at the first client device and from a second instance of the application at the second client device.

3. The first client device of claim 1, wherein the one or more media specifications comprise a maximum media file size for media content, and wherein to cause the instance of media content to be obtained, the at least one processor is configured to cause the first client device to communicate an instruction to a media capture device to capture the instance of media content with a file size that does not exceed the maximum media file size.

4. The first client device of claim 1, wherein the one or more media specifications are associated with one or more of digital image media or digital audio media, and where the instance of media content comprises one or more of an instance of digital image media or digital audio media obtained based at least in part on the one or more media specifications.

5. The first client device of claim 1, wherein the at least one processor is configured to cause the first client device to:
transmit, to the second client device, an indication that one or more media capture devices are activated on the first client device; and
receive, based at least in part on the indication, the one or more media specifications for media content.

6. The first client device of claim 5, wherein the indication comprises an indication that an application on the first client device activates the one or more media capture devices.

7. The first client device of claim 1, wherein the at least one processor is configured to cause the first client device to receive, from the second client device, a notification to activate one or more media capture devices and to capture the instance of media by the one or more media capture devices based at least in part on the one or more media specifications.

8. The first client device of claim 1, wherein to obtain the instance of media content, the at least one processor is configured to cause the first client device to:
search a data storage for previously captured media content that corresponds to the one or more media specifications; and
obtain the instance of media content from the previously captured media content of the data storage and based at least in part on the one or more media specifications.

9. The first client device of claim 8, wherein the one or more media specifications comprise metadata that describes subject matter for the instance of media content.

10. The first client device of claim 1, wherein the at least one processor is configured to cause the first client device to:
specify user guidance for adjusting one or more media capture attributes of a media capture device; and
capture, by a media capture device of the first client device, the instance of media content based at least in part on the one or more media specifications and the user guidance.

11. A second client device, comprising:
at least one memory; and
at least one processor coupled with the at least one memory and configured to cause the second client device to:
transmit, to a first client device, one or more media specifications for media content for an application;
receive, from the second client device, an instance of media content based at least in part on the one or more media specifications; and
provide the instance of media content to the application.

12. The second client device of claim 11, wherein the at least one processor is configured to cause the second client device to transmit a notification to the first client device to invoke a media capture device of the first client device for capturing the instance of media content.

13. The second client device of claim 12, wherein the notification comprises a notification generated by a first instance of the application at the second client device and configured for a second instance of the application at the first client device.

14. The second client device of claim 11, wherein the at least one processor is configured to cause the second client device to identify the one or more media specifications by analyzing a graphical user interface for the application to determine that the graphical user interface identifies the one or more media specifications.

15. The second client device of claim 11, wherein the one or more media specifications comprise a maximum media file size for media content.

16. The second client device of claim 11, wherein the at least one processor is configure to cause the second client device to:
receive a notification that a media capture device on the first client device is activated; and
transmit the one or more media specifications to the first client device based at least in part on the notification.

17. The second client device of claim 11, wherein the one or more media specifications comprise metadata that describes subject matter for the instance of media content.

18. The second client device of claim 11, wherein the at least one processor is configured to cause the second client device to transmit an indication specifying user guidance for adjusting one or more media capture attributes of a media capture device of the first client device.

19. The second client device of claim 11, wherein the at least one processor is configured to cause the second client device to:
determine that the instance of media content does not comply with at least one media specification of the one or more media specifications; and
transmit, to the first client device, a request for a further instance of media content that complies with the at least one media specification of the one or more media specifications.

20. A method, comprising:
receiving, at a first client device and from a second client device, one or more media specifications for media content;
causing an instance of media content to be obtained based at least in part on the one or more media specifications; and
transmitting, to the second client device, the instance of media content.
